(19) United States
(12) Patent Application Publication
(10) Pub. No.: US 2025/0173779 A1
(43) Pub. Date: May 29, 2025

(54) INFORMATION PROCESSING METHOD, INFORMATION PROCESSING DEVICE, AND NON-TRANSITORY COMPUTER READABLE RECORDING MEDIUM STORING INFORMATION PROCESSING PROGRAM

(71) Applicant: Panasonic Intellectual Property Corporation of America, Torrance, CA (US)

(72) Inventors: Sowyo MATSUMURA, Osaka (JP); Nobuaki TASAKI, Osaka (JP)

(21) Appl. No.: 19/003,160

(22) Filed: Dec. 27, 2024

Related U.S. Application Data
(63) Continuation of application No. PCT/JP2023/024857, filed on Jul. 5, 2023.

(30) Foreign Application Priority Data
Jul. 7, 2022 (JP) 2022-109590

(51) Int. Cl. G06Q 30/0645

(52) U.S. Cl. CPC G06Q 30/0645

(57) ABSTRACT

A server acquires deterioration degree, a charging rate, and initial full charge capacity of a battery pack mounted on the electric mobile object at a rental start time of the battery pack, calculates a power amount of the battery pack at the rental start time based on the deterioration degree, the charging rate, and the initial full charge capacity, calculates a rental fee of the electric mobile object incorporating a battery pack having a power amount less than current full charge capacity or a rental fee of a battery pack having a power amount less than current full charge capacity based on the power amount, and outputs the rental fee.

### FIELD OF INVENTION

The present disclosure relates to a technique for calculating a rental fee for a battery mounted on an electric mobile object.

### BACKGROUND ART

In recent years, small electric mobility has appeared, and renting a battery attachable to and detachable from electric mobility to the user has been studied.

For example, Patent Literature 1 discloses a server that collects full charge capacity of a battery for traveling mounted on a vehicle from the vehicle, and determines a rental charge paid by the user for renting of a battery according to the collected full charge capacity.

However, in the above-described conventional technique, there is a possibility of a shortage of rentable batteries, and further improvement has been required.
Patent Literature 1: JP 2020-177652 A

### SUMMARY OF THE INVENTION

The present disclosure has been made to solve the above problem, and an object of the present disclosure is to provide a technique capable of preventing a shortage of rentable batteries.

An information processing method according to the present disclosure is an information processing method in a computer, the method including acquiring deterioration degree, a charging rate, and initial full charge capacity of a battery mounted on an electric mobile object at a rental start time of the battery, calculating a power amount of the battery at the rental start time based on the deterioration degree, the charging rate, and the initial full charge capacity, calculating a rental fee of the electric mobile object incorporating the battery having the power amount less than current full charge capacity or a rental fee of the battery having the power amount less than current full charge capacity based on the power amount, and outputting the rental fee.

According to the present disclosure, it is possible to prevent a shortage of rentable batteries

### BRIEF DESCRIPTION OF THE DRAWINGS

FIG. 1 is a diagram illustrating an overall configuration of a battery pack rental system according to an embodiment of the present disclosure.

FIG. 2 is a diagram for describing renting and returning of a battery pack in a first embodiment.

FIG. 3 is a block diagram illustrating a configuration of a server in the first embodiment of the present disclosure.

FIG. 4 is a flowchart for describing a battery pack rental processing of the server according to the first embodiment of the present disclosure.

FIG. 5 is a flowchart for describing rental fee calculation processing of a rental fee calculation part in the first embodiment.

FIG. 6 is a diagram illustrating an example of a scheduled rental fee presentation image displayed on a user terminal in the first embodiment.

FIG. 7 is a diagram illustrating an example of a determined rental fee presentation image displayed on the user terminal in the first embodiment.

FIG. 8 is a block diagram illustrating a configuration of the server in a second embodiment of the present disclosure.

FIG. 9 is a flowchart for describing the rental fee calculation processing of the rental fee calculation part in the second embodiment.

FIG. 10 is a diagram illustrating an example of a scheduled rental fee presentation image displayed on the user terminal in the second embodiment.

### DETAILED DESCRIPTION

### (Findings as Basis of the Present Disclosure)

In the conventional technique, a rental charge paid by the user for renting a battery is determined according to full charge capacity of the battery. Normally, a fully charged battery is rented out to the user. However, in a case where only a fully charged battery is rented out, a battery cannot be rented out until the battery is fully charged, and there is a possibility of a shortage of rentable batteries. Further, since a service provider who rents out batteries needs to prepare extra batteries in order to cope with a shortage of batteries, there is a possibility of high service operation cost.

In order to solve the above problem, a technique below is disclosed.

(1) An information processing method according to one aspect of the present disclosure is an information processing method in a computer, the method including acquiring deterioration degree, a charging rate, and initial full charge capacity of a battery mounted on an electric mobile object at a rental start time of the battery, calculating a power amount of the battery at the rental start time based on the deterioration degree, the charging rate, and the initial full charge capacity, calculating a rental fee of the electric mobile object incorporating the battery having the power amount less than current full charge capacity or a rental fee of the battery having the power amount less than current full charge capacity based on the power amount, and outputting the rental fee.

According to this configuration, a power amount of a battery mounted on an electric mobile object at a rental start time is calculated based on deterioration degree, a charging rate, and initial full charge capacity of the battery at the rental start time of the battery. Then, based on the calculated power amount, a rental fee of the electric mobile object incorporating a battery having a power amount less than current full charge capacity or a rental fee of a battery having a power amount less than current full charge capacity is calculated, and the calculated rental fee is output.

Therefore, a rental fee of not only a battery that is fully charged but also a battery that is less than fully charged can be presented, and the number of rentable batteries increases, so that a shortage of rentable batteries can be prevented.

Further, it is possible to present a rental fee of not only an electric mobile object incorporating a battery that is fully charged but also an electric mobile object incorporating a battery that is less than fully charged, and since the number of rentable electric mobile objects increases, it is possible to prevent a shortage of rentable electric mobile objects.

(2) In the information processing method according to (1) above, in the calculating a rental fee, the rental fee may be calculated by multiplying the power amount at the rental start time by a predetermined constant.

According to this configuration, a rental fee can be calculated using a power amount at a rental start time.

(3) In the information processing method according (1) above, in the calculating a rental fee, deterioration degree and a charging rate of the battery at a scheduled rental end time of the battery may be estimated, a power amount at the scheduled rental end time may be calculated based on the deterioration degree, the charging rate, and the initial full charge capacity of the battery at the scheduled rental end time, and a value obtained by subtracting the power amount at the scheduled rental end time from the power amount at the rental start time may be multiplied by a predetermined constant to calculate the rental fee.

According to this configuration, a rental fee is calculated by multiplying a value obtained by subtracting a power amount at a scheduled rental end time from a power amount at a rental start time by a predetermined constant.

Therefore, a rental fee can be calculated using a power amount at a rental start time and a power amount at a scheduled rental end time, and a more accurate rental fee according to a power consumption amount of a battery can be calculated.

(4) In the information processing method according to any one of (1) to (3) above, in the calculating a rental fee, an operation rate in past of a battery station in which the battery is placed may be calculated, a first coefficient set for the battery station may be calculated based on the operation rate that is calculated, and the first coefficient that is calculated may be multiplied by the rental fee.

According to this configuration, the first coefficient set for a battery station where a battery is placed is calculated based on an operation rate in the past of the battery station, and a rental fee is multiplied by the calculated first coefficient.

Therefore, if an operation rate in the past of a battery station is high, a rental fee of a battery placed in the battery station can be increased by increasing a value of the first coefficient, and if an operation rate in the past of a battery station is low, a rental fee of a battery placed in the battery station can be reduced by decreasing a value of the first coefficient. For this reason, it is possible to prevent users from concentrating on one battery station.

(5) In the information processing method according to any one of (1) to (4) above, in the calculating a rental fee, a rental ratio at which a plurality of batteries are rented in past may be calculated for each of a plurality of predetermined charging rate ranges, a second coefficient set for each of a plurality of the predetermined charging rate ranges may be calculated based on the rental ratio for each of a plurality of the predetermined charging rate ranges that is calculated, and the rental fee may be multiplied by the second coefficient set for a range corresponding to the charging rate of the battery among a plurality of predetermined charging rate ranges.

According to this configuration, a rental ratio at which a plurality of batteries are rented in the past is calculated for each of a plurality of predetermined charging rate ranges. The second coefficient set for each of a plurality of the predetermined charging rate ranges is calculated based on the calculated rental ratio for each of a plurality of the predetermined charging rate ranges. A rental fee is multiplied by the second coefficient set for a range corresponding to a charging rate of a battery among a plurality of the predetermined charging rate ranges.

Therefore, for a charging rate range with a high rental ratio, a value of the second coefficient is increased, so that a rental fee of a battery having a charging rate at a rental start time corresponding to the charging rate range can be increased, and for a charging rate range with a low rental ratio, a value of the second coefficient is decreased, so that a rental fee of a battery having a charging rate at a rental start time corresponding to the charging rate range can be reduced. For this reason, it is possible to promote rental of a battery having a low charging rate at a rental start time, that is, a battery having a small power amount less than fully charged, and it is possible to prevent a shortage of rentable batteries.

(6) In the information processing method according to (5) above, in a case where a second coefficient set for a first charging rate range is larger than a second coefficient set for a second charging rate range larger than the first charging rate range, the second coefficient set for the second charging rate range may be replaced with the second coefficient set for the first charging rate range.

According to this configuration, the second coefficient can be increased as a charging rate range increases, and a rental fee of a battery having the first charging rate can be made equal to or less than a rental fee of a battery having the second charging rate higher than the first charging rate.

(7) In the information processing method according to any one of (1) to (6) above, in the calculating a rental fee, a moving distance per rental in past of the user who rents the battery may be converted into a power consumption amount, in a case where a current scheduled power consumption amount of the battery is smaller than a value obtained by subtracting a threshold from the power consumption amount that is converted, the rental fee may be multiplied by a third coefficient, in a case where the scheduled power consumption amount is within a range between a value obtained by subtracting the threshold from the power consumption amount that is converted and a value obtained by adding the threshold to the power consumption amount that is converted, the rental fee may be multiplied by a fourth coefficient higher than the third coefficient, and in a case where the scheduled power consumption amount is larger than a value obtained by adding the threshold to the power consumption amount that is converted, the rental fee may be multiplied by a fifth coefficient higher than the fourth coefficient.

According to this configuration, a moving distance per rental in the past of the user who rents a battery is converted into a power consumption amount. In a case where current scheduled power consumption amount of a battery is smaller than a value obtained by subtracting a threshold from the converted power consumption amount, a rental fee is multiplied by the third coefficient. Further, in a case where a scheduled power consumption amount is within a range between a value obtained by subtracting the threshold from a converted power consumption amount and a value obtained by adding the threshold to the converted power consumption amount, a rental fee is multiplied by the fourth coefficient higher than the third coefficient. Further, in a case where a scheduled power consumption amount is larger than a value obtained by adding the threshold to a converted power consumption amount, a rental fee is multiplied by the fifth coefficient higher than the fourth coefficient.

Therefore, if a current power consumption amount is smaller than a power consumption amount at the time of rental in the past, a rental fee is also reduced, so that it is possible to encourage the user to use a battery in a manner that a power consumption amount is reduced.

(8) The information processing method according to any one of (1) to (7) above may further include acquiring a departure point and a destination point of the electric mobile object on which the battery is mounted, converting a moving distance from the departure point to the destination point into a power consumption amount, and selecting a rentable battery in which the power amount of the battery at the rental start time is larger than the power consumption amount that is converted, in which in the calculating a rental fee, the calculating the rental fee of the rentable battery that is selected is calculated.

According to this configuration, a rentable battery in which a power amount of the battery at a rental start time is larger than a power consumption amount converted from a moving distance from a departure point to a destination point is selected, and a rental fee of the selected rentable battery is calculated.

Therefore, it is possible to exclude a battery with which a destination point cannot be reached from a departure point, and present only a rental fee of a battery with which the destination point can be reached from the departure point.

(9) The information processing method according to any one of (1) to (8) may further include acquiring deterioration degree, a charging rate, and initial full charge capacity of the battery at a rental end time of the battery, calculating a power amount at the rental end time based on the deterioration degree, the charging rate, and the initial full charge capacity, calculating a final rental fee of the battery based on the power amount, and outputting the final rental fee.

According to this configuration, a final rental fee of a battery is calculated based on a power amount at a rental end time, and the calculated final rental fee is output, so that the final rental fee can be presented to the user.

The present disclosure can be implemented not only as the information processing method for performing the characteristic processing as described above, but also as an information processing device or the like having a characteristic configuration corresponding to the characteristic processing performed by the information processing method. Further, the present disclosure can also be implemented as a computer program that causes a computer to execute characteristic processing included in the information processing method described above. Thus, an effect similar to that in the above information processing method can also be achieved by another aspect described below.

(10) An information processing device according to another aspect of the present disclosure includes an acquisition part that acquires deterioration degree, a charging rate, and initial full charge capacity of a battery mounted on an electric mobile object at a rental start time of the battery, a power amount calculation part that calculates a power amount of the battery at the rental start time based on the deterioration degree, the charging rate, and the initial full charge capacity, a rental fee calculation part that calculates a rental fee of the electric mobile object incorporating the battery having the power amount less than current full charge capacity or a rental fee of the battery having the power amount less than current full charge capacity based on the power amount, and an output part that outputs the rental fee.

(11) An information processing program according to another aspect of the present disclosure causes a computer to function to acquire deterioration degree, a charging rate, and initial full charge capacity of a battery mounted on an electric mobile object at a rental start time of the battery, calculate a power amount of the battery at the rental start time based on the deterioration degree, the charging rate, and the initial full charge capacity, calculate a rental fee of the electric mobile object incorporating the battery having the power amount less than current full charge capacity or a rental fee of the battery having the power amount less than current full charge capacity based on the power amount, and output the rental fee.

(12) A computer readable recording medium recording an information processing program according to another aspect of the present disclosure causes a computer to function to acquire deterioration degree, a charging rate, and initial full charge capacity of a battery mounted on an electric mobile object at a rental start time of the battery, calculate a power amount of the battery at the rental start time based on the deterioration degree, the charging rate, and the initial full charge capacity, calculate a rental fee of the electric mobile object incorporating the battery having the power amount less than current full charge capacity or a rental fee of the battery having the power amount less than current full charge capacity based on the power amount, and output the rental fee.

Hereinafter, an embodiment of the present disclosure will be described with reference to the accompanying drawings. Note that each of the embodiments to be described below shows one specific example of the present disclosure. The numerical values, shapes, constituent elements, steps, orders of the steps, and the like of the embodiments below are merely examples, and do not intend to limit the present disclosure. Further, among constituent elements according to the embodiments below, any constituent element not described in any independent claim representing the highest concept will be described as an optional constituent element. Further, in all the embodiments, content of each of the embodiments can be combined.

### First Embodiment

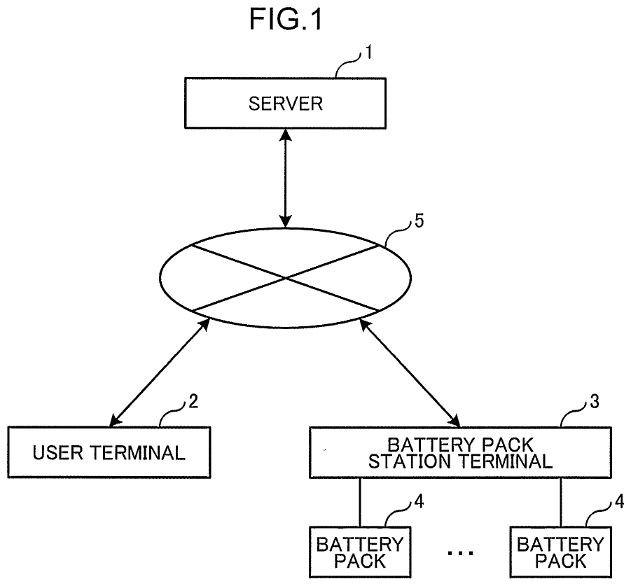

FIG. 1 is a diagram illustrating an overall configuration of a battery pack rental system according to an embodiment of the present disclosure.

The battery pack rental system illustrated in FIG. 1 includes a server 1, a user terminal 2, a battery pack station terminal 3, and a battery pack 4.

The user terminal 2 is, for example, a smartphone, a tablet computer, or a personal computer, and is used by the user who rents the battery pack 4. The user terminal 2 receives input of a departure point and a destination point by the user. The departure point represents a point where an electric mobile object on which the battery pack 4 is mounted starts to move and use of the battery pack 4 is started. The destination point represents a point where the electric mobile object on which the battery pack 4 is mounted finishes moving and use of the battery pack 4 is finished.

For example, the user terminal 2 may display a map and receive input by the user about an optional departure point and an optional destination point on the displayed map. Further, the user terminal 2 may receive input by the user about an address of an optional departure point and an optional destination point or a name of a facility.

Note that there is a case where a relay point where the user stops by between a departure point and a destination point. In this case, the user terminal 2 may receive input of the relay point in addition to input of the departure point and the destination point by the user. The user moves from the departure point to the destination point via the relay point. The user terminal 2 may receive input of not only one relay point but also a plurality of relay points. Further, a departure point and a destination point may be different places. That is, an electric mobile object may start moving at a departure point and end moving at a destination point at a place different from the departure point. Further, a departure point and a destination point may be the same place. That is, an electric mobile object may start moving at a departure point, pass through a relay point, and end moving at a destination point located at the same place as the departure point.

The user terminal 2 transmits rental request information including information for identifying the user, a departure point, and a destination point to the server 1. The information for identifying the user may be a user ID for identifying the user or a terminal ID for identifying the user terminal 2.

Further, when the user rents the battery pack 4, the user terminal 2 receives information indicating a rental fee of a plurality of the battery packs 4 within a predetermined distance range from a departure point, which is transmitted by the server 1. The user terminal 2 displays the received rental fee of a plurality of the battery packs 4. At this time, the user terminal 2 displays the rental fee in association with a number of a locker in which a plurality of the battery packs 4 are stored for each battery pack station. By the above, the user terminal 2 presents a rental fee of a plurality of the battery packs 4 within a predetermined distance range from a departure point to the user who desires to rent the battery pack 4. The user moves to a battery pack station having a locker that stores the battery pack 4 that the user desires to rent among a plurality of the battery packs 4 displayed on the user terminal 2.

Further, when the user returns the battery pack 4, the user terminal 2 receives information indicating a final rental fee of the battery pack 4 rented by the user, the information being transmitted by the server 1. The user terminal 2 displays the received final rental fee of the battery pack 4. By the above, the user terminal 2 presents the final rental fee for the battery pack 4 to the user who rents the battery pack 4. The user pays the final rental fee for the battery pack 4 displayed on the user terminal 2.

Further, when the user rents the battery pack 4, the user terminal 2 may receive information transmitted by the server 1 and indicating a locker of a battery pack station to which the battery pack 4 is to be returned within a predetermined distance range from a destination point. The user terminal 2 may display a number of a locker of a battery pack station to which the battery pack 4 is to be returned. Note that when the user arrives at a destination point, the user terminal 2 may accept a search by the user for a battery pack station around the destination point, and present the user with a locker of a battery pack station to which the battery pack 4 is to be returned. For example, a battery pack station closest to a destination point and having an available locker is presented.

The battery pack 4 includes a plurality of secondary batteries, and stores electric power by charging and supplies electric power by discharging. The secondary battery is, for example, a lead acid battery or a lithium ion battery. The battery pack 4 is an example of a battery.

The battery pack station terminal 3 is installed in a battery pack station in which a plurality of the battery packs 4 are placed. At the start of rental of the battery pack 4, the battery pack station terminal 3 receives input of a user ID for identifying the user who uses the battery pack 4, and receives input of a battery pack ID for identifying the battery pack 4 used by the user. The user ID may be manually input by the user, or may be input by reading of a barcode or a two-dimensional code displayed on a smartphone or the like. The battery pack ID may be manually input by a user, or may be input by reading of a bar code or a two-dimensional code attached to a surface of the battery pack 4.

Further, at the time of returning of the battery pack 4, the battery pack station terminal 3 receives input of a user ID for identifying the user who uses the battery pack 4, and receives input of a battery pack ID for identifying the battery pack 4 used by the user.

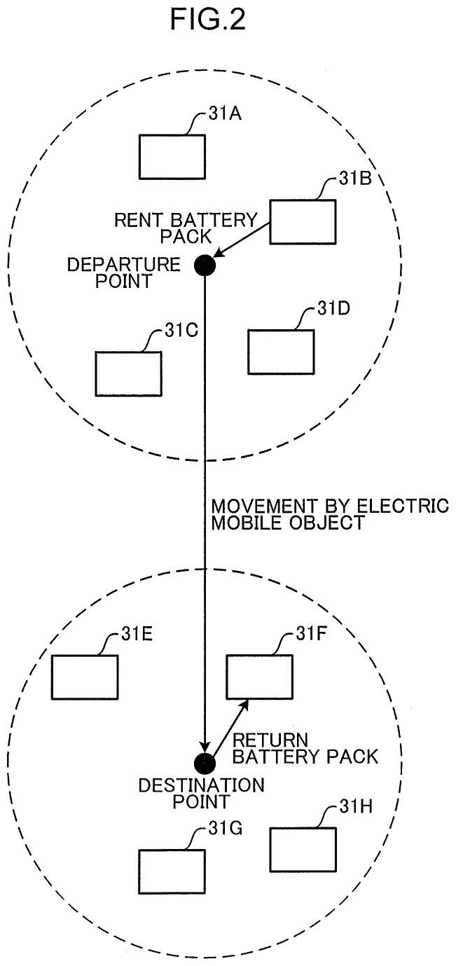

FIG. 2 is a diagram for describing renting and returning of a battery pack in the first embodiment.

A plurality of the battery packs 4 are placed in battery pack stations 31A to 31H. A plurality of lockers are installed in the battery pack stations 31A to 31H, and the battery pack 4 is stored in each of the lockers. For example, among the battery pack stations 31A to 31D within a predetermined distance range from a departure point, the battery pack 4 is rented out to the user at the battery pack station 31B. The predetermined distance range is, for example, a circle having a radius of 2 km around a departure point. A circle indicated by a broken line in FIG. 2 represents the predetermined distance range. The user takes out the battery pack 4 from the inside of a locker, and attaches the battery pack 4 that is taken out to an electric mobile object used by the user. The electric mobile object is, for example, an electric motorcycle. The user moves from a departure point to a destination point on the electric mobile object. The electric mobile object moves by supplying electric power charged in the battery pack 4 to an electric motor.

When arriving at a destination point, the user takes out the battery pack 4 from the electric mobile object, and puts the battery pack 4 that is taken out into a locker. For example, among the battery pack stations 31E to 31H within a predetermined distance range from a destination point, the battery pack 4 is returned from the user at the battery pack station 31F. The predetermined distance range is, for example, a circle having a radius of 2 km around a destination point. The battery pack stations 31A to 31H are provided with a charging device. A cable for charging and data communication is provided in a locker. The user connects the battery pack 4 to the cable when putting the battery pack 4 in a locker. By the above, the battery pack 4 is charged by the charging device, and information of the battery pack 4 is output to the battery pack station terminal 3. Note that charging of the battery pack 4 and communication with the battery pack 4 may be performed wirelessly. Further, the battery pack 4 that is not fully charged and put in a locker is also a target of rental.

Further, a battery pack station may not be provided with a charging device. In this case, the battery pack 4 having reduced remaining capacity is transported from a battery pack station to a place where a charging device is located. Further, the battery pack 4 that is fully charged is transported from a place where a charging device is located to a battery pack station.

The battery pack station terminal 3 transmits, to the server 1, battery information including a station ID for identifying a battery pack station in which the battery pack 4 is present, a locker ID for identifying a locker in which the battery pack 4 is stored, a battery pack ID for identifying the battery pack 4, and a state of health (SOH), a state of charge (SOC), and a FCC (full charge capacity) at an initial state (at the time of shipment) of the battery pack 4. SOH is an index representing deterioration degree of the battery pack 4, and SOC is an index representing a charging rate of the battery pack 4. SOH is represented by (full charge capacity [Ah] at present (at the time of deterioration)/initial full charge capacity [Ah])*100. SOC is represented by (power amount at present (remaining capacity) [Ah]/full charge capacity at present (at the time of deterioration) [Ah])*100.

The battery pack 4 calculates an SOH and an SOC. The battery pack 4 stores initial FCC in advance. The battery pack 4 periodically outputs a battery pack ID, an SOH, an SOC, and initial FCC to the battery pack station terminal 3. For example, the battery pack 4 outputs a battery pack ID, an SOH, an SOC, and initial FCC to the battery pack station terminal 3 every minute. Note that a method for calculating an SOH and an SOC is a conventional technique, and thus will be omitted from description.

Further, when the battery pack 4 is returned to a battery pack station, the battery pack 4 outputs, to the battery pack station terminal 3, a battery pack ID, an SOH, an SOC, initial FCC, and a moving distance from a departure point to a destination point of the battery pack 4. The battery pack 4 measures a moving distance from a departure point to a destination point.

Note that, in the first embodiment, the battery pack 4 calculates an SOH and an SOC, but the present disclosure is not particularly limited to this, and the battery pack station terminal 3 may calculate an SOH and an SOC of the battery pack 4. Further, the server 1 may calculate an SOH and an SOC of the battery pack 4.

The battery pack station terminal 3 periodically transmits battery information including a station ID, a locker ID, a battery pack ID of the battery pack 4, an SOH, an SOC, and initial FCC to the server 1. For example, the battery pack station terminal 3 transmits battery information to the server 1 every minute. Further, when the battery pack 4 is rented out to the user, the battery pack station terminal 3 transmits, to the server 1, rental information including a user ID for identifying the user to whom the battery pack 4 is rented out and battery information. Furthermore, when the battery pack 4 is returned to a battery pack station, the battery pack station terminal 3 transmits, to the server 1, return information including a user ID for identifying the user who returns the battery pack 4, a moving distance from a departure point to a destination point, and battery information.

Note that a departure point and a battery pack station may be located at the same position or different positions. Further, a destination point and a battery pack station may be located at the same position or different positions.

The server 1 calculates a rental fee for the battery pack 4. When the user rents the battery pack 4, the server 1 calculates a rental fee of a plurality of the battery packs 4 within a predetermined distance range from a departure point. Further, when the user returns the battery pack 4, the server 1 calculates a final rental fee of the battery pack 4 rented by the user.

The server 1 is connected to the user terminal 2 and the battery pack station terminal 3 in a manner that communication can be performed via the network 5. The network 5 is the Internet, for example.

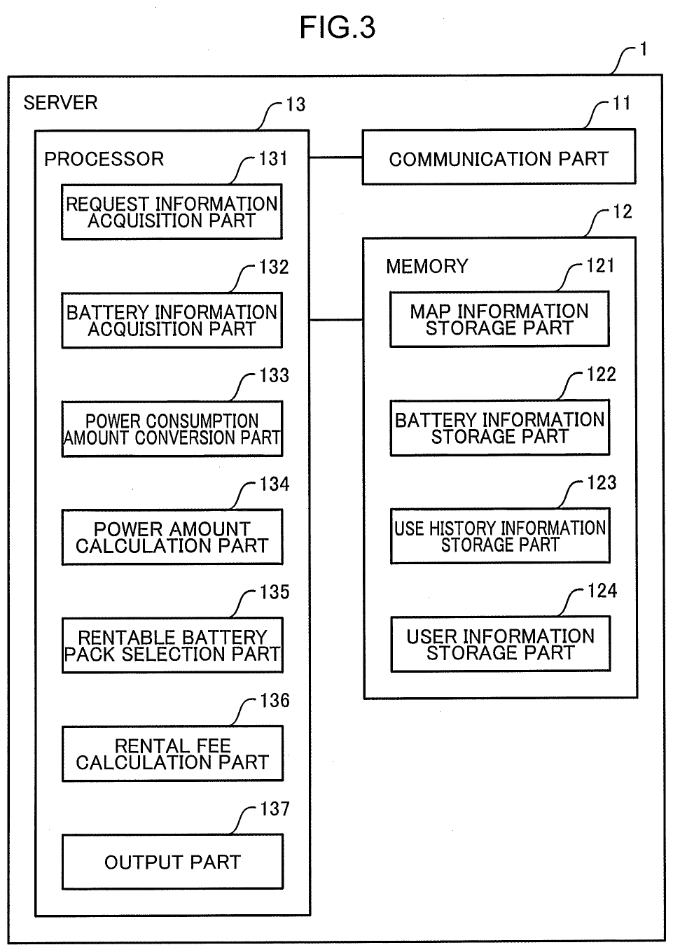

FIG. 3 is a block diagram illustrating a configuration of the server 1 in the first embodiment of the present disclosure.

The server 1 includes a communication part 11, a memory 12, and a processor 13.

The communication part 11 receives battery information periodically transmitted by the battery pack station terminal 3. The battery information includes a station ID, a locker ID, a battery pack ID, an SOH, an SOC, and initial FCC. Further, the communication part 11 receives rental information transmitted by the battery pack station terminal 3. The rental information includes a user ID of the user to whom the battery pack 4 is rented out and battery information. Further, the communication part 11 receives return information transmitted by the battery pack station terminal 3. The return information includes a user ID of the user who returns the battery pack 4, a moving distance from a departure point to a destination point, and battery information.

Further, the communication part 11 receives rental request information transmitted by the user terminal 2. The rental request information includes a user ID of the user who desires to rent the battery pack 4, a departure point, and a destination point. Furthermore, the communication part 11 transmits information indicating a rental fee of the battery pack 4 to the user terminal 2. When the battery pack 4 is rented out to the user, the communication part 11 transmits information indicating rental fees of a plurality of the battery packs 4 within a predetermined distance range from a departure point to the user terminal 2. Further, when the battery pack 4 is returned from the user, the communication part 11 transmits information indicating a final rental fee of the battery pack 4 rented by the user to the user terminal 2.

The memory 12 is a storage device capable of storing various types of information, such as a random access memory (RAM), a hard disk drive (HDD), a solid state drive (SSD), or a flash memory. The memory 12 realizes a map information storage part 121, a battery information storage part 122, a use history information storage part 123, and a user information storage part 124.

The processor 13 is, for example, a central processing unit (CPU). The processor 13 realizes a request information acquisition part 131, a battery information acquisition part 132, a power consumption amount conversion part 133, a power amount calculation part 134, a rentable battery pack selection part 135, a rental fee calculation part 136, and an output part 137.

Note that the request information acquisition part 131 to the output part 137 and the map information storage part 121 to the user information storage part 124 may be configured by a dedicated hardware circuit. Further, the request information acquisition part 131 to the output part 137 and the map information storage part 121 to the user information storage part 124 may be dispersedly arranged in a plurality of devices.

The map information storage part 121 stores map information indicating a map in advance.

The battery information storage part 122 stores battery information of each of a plurality of the battery packs 4. The battery information includes a battery pack ID, a station ID, a locker ID, an SOH, an SOC, and initial FCC. The communication part 11 stores the received battery information in the battery information storage part 122. Since the battery information is periodically received, battery information stored in the battery information storage part 122 is periodically updated.

The use history information storage part 123 stores use history information indicating a use history of each of the battery packs 4. The use history information includes a battery pack ID of a battery pack that is rented out, rental start date and time of the battery pack 4, a station ID and a locker ID of a battery pack station from which the battery pack 4 is rented out, an SOH, an SOC, and initial FCC of the battery pack 4 at a rental start time, rental end date and time of the battery pack 4, a station ID and a locker ID of a battery pack station to which the battery pack 4 is returned, and an SOH, an SOC, and initial FCC of the battery pack 4 at a rental end time. Note that the use history information stored in the use history information storage part 123 is not limited to the above.

The user information storage part 124 stores user information in which a user ID for identifying the user, a battery pack ID of the battery pack 4 rented by the user, rental start date and time of the battery pack 4, rental end date and time of the battery pack 4, and a moving distance are associated with each other.

The request information acquisition part 131 acquires a departure point and a destination point of an electric mobile object on which the battery pack 4 is mounted. The request information acquisition part 131 acquires a departure point and a destination point included in rental request information received by the communication part 11.

The battery information acquisition part 132 acquires an SOH (deterioration degree), an SOC (charging rate), and initial FCC (full charge capacity) of the battery pack 4 at a rental start time of the replaceable battery pack 4 mounted on an electric mobile object.

The power consumption amount conversion part 133 converts a moving distance from a departure point to a destination point acquired by the request information acquisition part 131 into a power consumption amount. At this time, the power consumption amount conversion part 133 refers to map information stored in the map information storage part 121, and estimates a moving route from a departure point to a destination point. The moving route from a departure point to a destination point is calculated using a route search algorithm of a conventional technique. In a route search algorithm, a moving route with a shortest moving distance or a moving route with shortest moving time is calculated. The power consumption amount conversion part 133 estimates a moving distance from the estimated moving route. The power consumption amount conversion part 133 converts the estimated moving distance into a power consumption amount. The power consumption amount conversion part 133 has a function for converting a moving distance into a power consumption amount, and calculates a power consumption amount by substituting an estimated moving distance into the function. Note that the power consumption amount conversion part 133 may have a plurality of different functions for each vehicle type of an electric mobile object, and may use a function corresponding to a vehicle type of an electric mobile object used by the user. Further, the power consumption amount conversion part 133 may have one function common to all vehicle types of electric mobile objects.

The power amount calculation part 134 calculates a power amount of the battery pack 4 at a rental start time based on an SOH (deterioration degree), an SOC (charging rate), and initial FCC (full charge capacity) acquired by the battery information acquisition part 132. The power amount calculation part 134 calculates a power amount ep0 of the battery pack 4 at a rental start time t0 based on Equation (1) below.

$$ep 0 = SOH * SOC * Initial FCC \qquad ( 1 )$$

The rentable battery pack selection part 135 selects the rentable battery pack 4 in which a power amount of the battery pack 4 at a rental start time calculated by the power amount calculation part 134 is larger than a power consumption amount converted by the power consumption amount conversion part 133. The rentable battery pack selection part 135 extracts a plurality of the battery packs 4 at a battery pack station within a predetermined distance range from a departure point, and selects the rentable battery pack 4 from among a plurality of the battery packs 4 that are extracted.

The rental fee calculation part 136 calculates a rental fee of the battery pack 4 whose power amount is less than current full charge capacity based on a power amount calculated by the power amount calculation part 134. The rental fee calculation part 136 calculates a rental fee of the rentable battery pack 4 selected by the rentable battery pack selection part 135.

Note that the rental fee calculation part 136 may calculate a rental fee of an electric mobile object incorporating the battery pack 4 whose power amount is less than current full charge capacity based on a power amount calculated by the power amount calculation part 134. The rental fee calculation part 136 may calculate a rental fee of an electric mobile object incorporating the rentable battery pack 4 selected by the rentable battery pack selection part 135.

The rental fee calculation part 136 calculates a rental fee by multiplying the power amount ep0 at the rental start time to by a predetermined constant. The predetermined constant is determined by a provider.

Note that the rental fee calculation part 136 may estimate an SOH (deterioration degree) and an SOC (charging rate) of the battery pack 4 at a scheduled rental end time t1 of the battery pack 4. The rental fee calculation part 136 calculates moving time by dividing a moving distance from a departure point to a destination point by a speed of an electric mobile object, and estimates the scheduled rental end time t1 by adding the moving time to the rental start time to. The rental fee calculation part 136 may calculate a power amount ep1 at the scheduled rental end time t1 based on an SOH (deterioration degree), an SOC (charging rate), and initial full charge capacity (FCC) of the battery pack 4 at the scheduled rental end time t1. The rental fee calculation part 136 may calculate a rental fee by multiplying a value obtained by subtracting the power amount ep1 at the scheduled rental end time t1 from the power amount ep0 at the rental start time to by a predetermined constant.

Note that the rental fee calculation part 136 may calculate the power amount ep1 at the scheduled rental end time t1 by multiplying a power consumption amount converted by the power consumption amount conversion part 133 by a predetermined constant.

Further, the rental fee calculation part 136 may calculate a rental fee by multiplying moving time from the rental start time t0 to the scheduled rental end time t1 by a predetermined constant. The predetermined constant is determined by a provider. The moving time is estimated from a moving route from a departure point to a destination point.

The rental fee calculation part 136 calculates a past operation rate os_rate of a battery pack station in which the battery pack 4 is placed, calculates a first coefficient ds_rate set for the battery pack station based on the calculated operation rate os_rate, and multiplies a rental fee by the calculated first coefficient ds_rate. Note that the calculation of the first coefficient ds_rate will be described later.

Further, the rental fee calculation part 136 calculates a rental ratio op_rate of a plurality of the battery packs 4 rented in the past for each of a plurality of predetermined SOC (charging rate) ranges, calculates a second coefficient dp_rate set for each of a plurality of predetermined SOC ranges based on the calculated rental ratio op_rate for each of a plurality of predetermined SOC ranges, and multiplies a rental fee by the second coefficient dp_rate set for a range to which an SOC (charging rate) of the battery pack 4 corresponds among a plurality of predetermined SOC ranges. Note that the calculation of the second coefficient dp_rate will be described later.

Further, in a case where the second coefficient dp_rate set for a first SOC (charging rate) range is larger than the second coefficient dp_rate set for a second SOC range larger than a first SOC range, the rental fee calculation part 136 replaces the second coefficient dp_rate set for the second SOC range with the second coefficient dp_rate set for the first SOC range. Note that the replacement of the second coefficient dp_rate will be described later.

The output part 137 outputs a rental fee calculated by the rental fee calculation part 136. The output part 137 outputs a rental fee at a rental start time.

Further, the battery information acquisition part 132 acquires an SOH (deterioration degree), an SOC (charging rate), and initial FCC (full charge capacity) of the battery pack 4 at a rental end time of the battery pack 4.

Further, the power amount calculation part 134 calculates a power amount of the battery pack 4 at a rental end time based on an SOH (deterioration degree), an SOC (charging rate), and initial FCC (full charge capacity) acquired at a rental end time by the battery information acquisition part 132.

Further, the rental fee calculation part 136 calculates a final rental fee of the battery pack 4 based on a power amount at a rental end time calculated by the power amount calculation part 134.

Further, the output part 137 outputs a final rental fee calculated by the rental fee calculation part 136. The output part 137 outputs a final rental fee at a rental end time.

Next, battery pack rental processing of the server 1 according to the first embodiment of the present disclosure will be described.

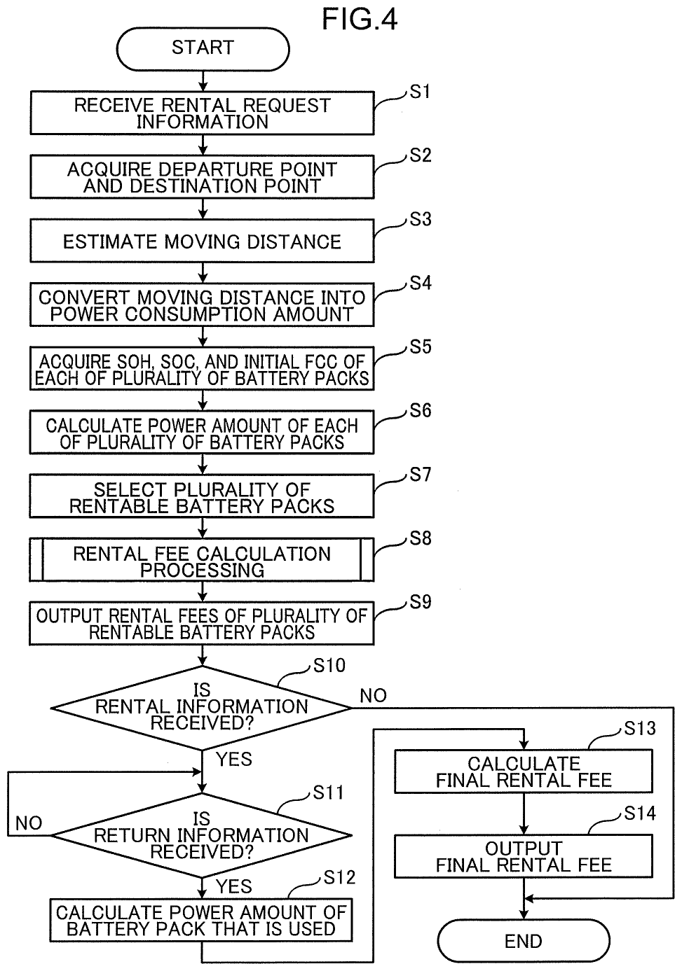

FIG. 4 is a flowchart for describing the battery pack rental processing of the server 1 according to the first embodiment of the present disclosure.

First, in step S1, the communication part 11 receives rental request information transmitted by the user terminal 2.

Next, in step S2, the request information acquisition part 131 acquires a departure point and a destination point of an electric mobile object on which the battery pack 4 to be rented is mounted. The request information acquisition part 131 acquires a departure point and a destination point included in the rental request information.

Next, in step S3, the power consumption amount conversion part 133 estimates a moving distance from a departure point to a destination point. The power consumption amount conversion part 133 refers to map information stored in the map information storage part 121, estimates a moving route from a departure point to a destination point, and estimates a moving distance from the estimated moving route.

Next, in step S4, the power consumption amount conversion part 133 converts the estimated moving distance into a power consumption amount.

Next, in step S5, the battery information acquisition part 132 acquires an SOH, an SOC, and initial FCC at a rental start time of each of a plurality of the battery packs 4 within a predetermined distance range from the departure point. The map information includes a position of a battery pack station. The battery information acquisition part 132 refers to the map information, identifies a battery pack station within a predetermined distance range from the departure point, and acquires an SOH, an SOC, and initial FCC of a plurality of the battery packs 4 at the identified battery pack station from the battery information storage part 122.

Next, in step S6, the power amount calculation part 134 calculates a power amount of each of a plurality of the battery packs 4 at a rental start time based on an SOH, an SOC, and initial FCC of each of a plurality of the battery packs 4 acquired by the battery information acquisition part 132. The power amount calculation part 134 calculates the power amount ep0 of each of a plurality of the battery packs 4 by using Equation (1) above. The power amount ep0 corresponds to remaining capacity of the battery pack 4.

Next, in step S7, the rentable battery pack selection part 135 selects a plurality of the rentable battery packs 4 in which the power amount ep0 of the battery pack 4 at a rental start time calculated by the power amount calculation part 134 is larger than the power consumption amount converted by the power consumption amount conversion part 133 from among a plurality of the battery packs 4 within a predetermined distance range from the departure point. At this time, the rentable battery pack selection part 135 selects not only the rentable battery pack 4 that is fully charged but also the rentable battery pack 4 that is not fully charged.

Next, in step S8, the rental fee calculation part 136 performs rental fee calculation processing for calculating a rental fee of each of a plurality of the rentable battery packs 4 based on a power amount of each of a plurality of the rentable battery packs 4. At this time, the rental fee calculation part 136 calculates not only a rental fee of a rentable battery pack that is fully charged but also a rental fee of a rentable battery pack that is not fully charged.

Here, the rental fee calculation processing of the rental fee calculation part 136 in step S8 will be described in more detail.

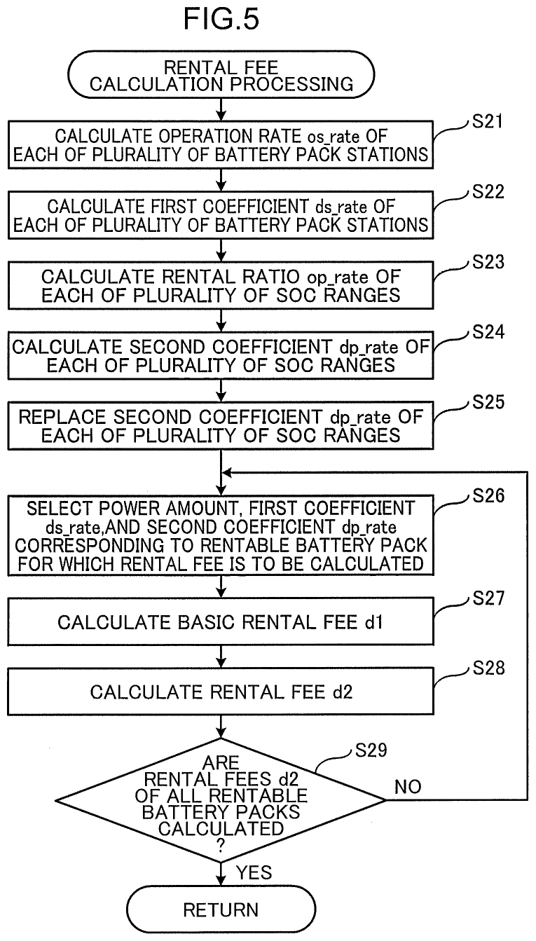

FIG. 5 is a flowchart for describing the rental fee calculation processing of the rental fee calculation part 136 in the first embodiment.

First, in step S21, the rental fee calculation part 136 refers to use history information stored in the use history information storage part 123, and calculates the past operation rates os_rate of a plurality of battery pack stations in which a plurality of the rentable battery packs 4 are placed. The rental fee calculation part 136 calculates the operation rate os_rate of each battery pack station for each predetermined time zone on each day of the week of a previous month based on Equation (2) below. The predetermined time zone is, for example, two hours.

$$os\_rate = ( total rental time of each battery pack / total operation time of each battery pack ) * 100 \qquad ( 2 )$$

For example, the rental fee calculation part 136 calculates the operation rate os_rate of each battery pack station between 8:00 and 10:00 on Monday of a previous month. For example, in a case where a certain battery pack station has ten rentable battery packs from 8:00 to 10:00 on Monday of a previous month, and five of the rentable battery packs are rented from 8:00 to 10:00, the operation rate os_rate of the certain battery pack station from 8:00 to 10:00 on Monday is 50% (=(5 battery packs*2 hours/10 battery packs*2 hours)*100). Note that an average of the operation rates os_rate between 8:00 and 10:00 on all Mondays of a previous month may be calculated, or the operation rate os_rate between 8:00 and 10:00 on Monday in a certain week of a previous month may be calculated.

Next, in step S22, the rental fee calculation part 136 calculates the first coefficient ds_rate set for each of a plurality of battery pack stations based on the calculated operation rate os_rate for each of a plurality of battery pack stations. The rental fee calculation part 136 calculates the first coefficient ds_rate of each battery pack station for each predetermined time zone on each day of the week in a previous month based on Equation (3) below. The predetermined time is, for example, two hours.

$$ds\_rate = \{ ( os\_rate - os\_min ) / ( os\_max - os\_min ) \} * ( ds\_max - ds\_min ) + ds\_min \qquad ( 3 )$$

In Equation (3) above, os_rate is an operation rate of a predetermined battery pack station in a predetermined time zone on a predetermined day of the week of a previous month, os_min is a minimum value of an operation rate of a plurality of battery pack stations in a predetermined time zone on a predetermined day of the week of a previous month, os_max is a maximum value of an operation rate of a plurality of battery pack stations in a predetermined time zone on a predetermined day of the week of a previous month, ds_max is a maximum value of a first coefficient of a predetermined battery pack station in a predetermined time zone on a predetermined day of the week of a previous month, and ds_min is a minimum value of a first coefficient of a predetermined battery pack station in a predetermined time zone on a predetermined day of the week of a previous month. Note that ds_max and ds_min are determined in advance by a provider and stored in the memory 12. A value of ds_max is, for example, 1.5, and a value of ds_min is, for example, 0.5.

Note that in the first embodiment, the operation rate os_rate and the first coefficient ds_rate are calculated from use history information for one month of a previous month. However, the present disclosure is not particularly limited to this, and the operation rate os_rate and the first coefficient ds_rate may be calculated from use history information for one year.

Further, the rental fee calculation part 136 may calculate the first coefficient ds_rate of each battery pack station of the same day of the week and time zone as the rental start date and time.

Next, in step S23, the rental fee calculation part 136 refers to use history information stored in the use history information storage part 123, and calculates the rental ratio op_rate at which a plurality of the rentable battery packs 4 are rented in a previous month for each of a plurality of predetermined SOC ranges. The predetermined SOC range is, for example, a range of every 10%, and ranges of 1% to 10%, 11% to 20%, 21% to 30%, . . . , and 91% to 100%. The rental fee calculation part 136 calculates the rental ratio op_rate of a previous month for each SOC range based on Equation (4) below.

$$op\_rate = ( total number of times of rental of rentable battery pack in predetermined SOC range rented in previous month / total number of times of rental of all rentable battery packs rented in a previous month ) * 100 \qquad ( 4 )$$

For example, the rental fee calculation part 136 calculates a rental ratio op_rate indicating a ratio of the number of times of rental of the rentable battery pack 4 having an SOC within a range of 1% to 10% to the number of times of rental of all rentable battery packs rented in a previous month. For example, in a case where the number of times all rentable battery packs are rented out in a previous month is 100, and the number of times the rentable battery pack 4 having an SOC in the range of 1% to 10% is rented out in a previous month is 5, the rental ratio op_rate in the SOC range of 1% to 10% is 5% (=(5 times/100 times)*100).

Next, in step S24, the rental fee calculation part 136 calculates the second coefficient dp_rate set for each of a plurality of predetermined SOC ranges based on the calculated rental ratio op_rate for each of a plurality of predetermined SOC ranges. The rental fee calculation part 136 calculates the second coefficient dp_rate for each of a plurality of predetermined SOC ranges based on Equation (5) below.

$$dp\_rate = \{ ( op\_rate - op\_min ) / ( op\_max - op\_min ) \} * ( dp\_max - dp\_min ) + dp\_min \qquad ( 5 )$$

In Equation (5) above, op_rate represents a rental ratio of a plurality of the rentable battery packs 4 in a predetermined SOC range, op_min represents a minimum value of a rental ratio of a plurality of the rentable battery packs 4 in a predetermined SOC range, op_max represents a maximum value of a rental ratio of a plurality of the rentable battery packs 4 in a predetermined SOC range, dp_max represents a maximum value of a second coefficient in a predetermined SOC range, and dp_min represents a minimum value of the second coefficient in a predetermined SOC range. Note that dp_max and dp_min are determined in advance by a provider and stored in the memory 12. A value of dp_max is, for example, 1.1, and a value of dp_min is, for example, 0.5.

Note that in the first embodiment, the rental ratio op_rate and the second coefficient dp_rate are calculated from use history information for one month of a previous month, but the present disclosure is not particularly limited to this, and the rental ratio op_rate and the second coefficient dp_rate may be calculated from use history information for one year.

Next, in step S25, in a case where the second coefficient dp_rate set for a first SOC range is larger than the second coefficient dp_rate set for a second SOC range larger than a first SOC range, the rental fee calculation part 136 replaces the second coefficient dp_rate set for the second SOC range with the second coefficient dp_rate set for the first SOC range. For example, in a case where the second coefficient dp_rate in an SOC range of 1% to 10% is 0.3 and the second coefficient dp_rate in an SOC range of 11% to 20% is 0.2, the second coefficient dp_rate in the SOC range of 11% to 20% is replaced from 0.2 to 0.3.

Note that in a case where the second coefficient dp_rate set for the first SOC range is equal to or less than the second coefficient dp_rate set for the second SOC range, the rental fee calculation part 136 does not replace the second coefficient dp_rate set for the second SOC range with the second coefficient dp_rate set for the first SOC range.

As described above, the rental fee calculation part 136 compares the second coefficients dp_rate of two adjacent SOC ranges, and replaces the second coefficient dp_rate of an SOC range that is higher with the second coefficient dp_rate of an SOC range that is lower in a case where the second coefficient dp_rate of the SOC range that is lower is larger than the second coefficient dp_rate of the SOC range that is higher. The rental fee calculation part 136 repeatedly performs comparison and replacement of the second coefficients dp_rate of two adjacent SOC ranges from a lowest SOC range to a highest SOC range.

Next, in step S26, the rental fee calculation part 136 selects the power amount ep0, the first coefficient ds_rate, and the second coefficient dp_rate corresponding to a rentable battery pack for which a rental fee is to be calculated. For example, in a case where a rental start time is 9:00 on Monday and a rentable battery pack subjected to calculation is placed in the battery pack station 31B, the rental fee calculation part 136 selects the first coefficient ds_rate of the battery pack station 31B from 8:00 to 11:00 on Monday. Further, for example, in a case where an SOC of a rentable battery pack subjected to calculation is 35%, the rental fee calculation part 136 selects the second coefficient dp_rate of the SOC range of 31% to 40%.

Next, in step S27, the rental fee calculation part 136 calculates a basic rental fee d1 by multiplying the power amount ep0 by a predetermined constant.

Next, in step S28, the rental fee calculation part 136 calculates a rental fee d2 by multiplying the basic rental fee d1 calculated in step S27 by the selected first coefficient ds_rate and second coefficient dp_rate. The rental fee calculation part 136 calculates the rental fee d2 based on Equation (6) below.

$$d 2 = d 1 * ds\_rate * dp\_rate \qquad ( 6 )$$

Next, in step S29, the rental fee calculation part 136 determines whether or not the rental fees d2 of all rentable battery packs are calculated. Here, in a case where it is determined that the rental fees d2 of all rentable battery packs are not calculated (NO in step S29), the processing returns to step S26, and the rental fee calculation part 136 selects the power amount ep0, the first coefficient ds_rate, and the second coefficient dp_rate corresponding to a rentable battery pack for which the rental fee d2 is not calculated.

On the other hand, in a case where it is determined that the rental fees d2 of all rentable battery packs are calculated (YES in step S29), the processing proceeds to step S9 in FIG. 4.

Returning to FIG. 4, next, in step S9, the output part 137 outputs rental fees of a plurality of the rentable battery packs 4 calculated by the rental fee calculation part 136. The communication part 11 transmits, to the user terminal 2, information indicating the rental fees of a plurality of the rentable battery packs 4 output by the output part 137. The user terminal 2 receives information indicating the rental fees of a plurality of the rentable battery packs 4 transmitted by the server 1. Then, the user terminal 2 displays the rental fees of a plurality of the rentable battery packs 4.

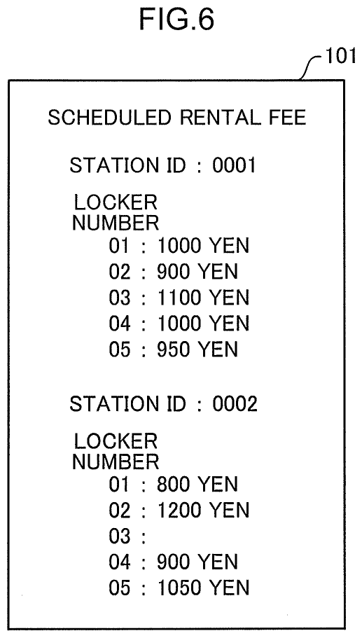

FIG. 6 is a diagram illustrating an example of a scheduled rental fee presentation image displayed on the user terminal 2 in the first embodiment. A display part of the user terminal 2 displays a scheduled rental fee presentation image 101 illustrated in FIG. 6.

The scheduled rental fee presentation image 101 illustrated in FIG. 6 includes scheduled rental fees for a plurality of the rentable battery packs 4. The scheduled rental fee presentation image 101 includes a station ID of a battery pack station, a number of a locker installed in a battery pack station, and a scheduled rental fee of a battery pack stored in each locker. The rental fee is presented for each battery pack station. By checking the scheduled rental fee presentation image 101 displayed on the user terminal 2, the user can know rental fees of a plurality of the rentable battery packs 4, and can determine which of the battery packs 4 to rent.

Note that in the scheduled rental fee presentation image 101, a rental fee is not displayed for a battery pack already being rented.

Further, a rental fee per hour may be displayed, or a rental fee per km may be displayed.

Returning to FIG. 4, next, in step S10, the communication part 11 determines whether or not rental information transmitted by the battery pack station terminal 3 is received. In a case where the rentable battery pack 4 is rented out to the user in a battery pack station, the battery pack station terminal 3 transmits rental information including a user ID and battery information to the server 1. After the rentable battery pack 4 is rented out to the user, the user rides on an electric mobile object on which the rentable battery pack 4 is mounted, and moves from a departure point to a destination point.

Here, in a case where it is determined that the rental information is not received (NO in step S10), the processing ends. Note that, in a case where the rental information is not received even after predetermined time elapses, the processing may end.

On the other hand, in a case where it is determined that the rental information is received (YES in step S10), in step S11, the communication part 11 determines whether or not return information transmitted by the battery pack station terminal 3 is received. In a case where the user returns the battery pack 4 at a battery pack station near a destination point, the battery pack station terminal 3 transmits return information including a user ID, a moving distance, and battery information to the server 1.

Here, in a case where it is determined that the return information is not received (NO in step S11), the processing of step S11 is repeated until the return information is received. On the other hand, in a case where it is determined that the return information is received (YES in step S11), in step S12, the rental fee calculation part 136 calculates the power amount ep1 of the battery pack 4 at a rental end time based on an SOH, an SOC, and initial FCC of the battery pack 4 at a rental end time included in the return information.

Next, in step S13, the rental fee calculation part 136 calculates a final rental fee of the battery pack 4 based on the power amount ep1 at the rental end time calculated by the power amount calculation part 134. At this time, the rental fee calculation part 136 selects the power amount ep0, the first coefficient ds_rate, and the second coefficient dp_rate at the rental start time corresponding to the rented battery pack. The rental fee calculation part 136 calculates the basic rental fee d1 by multiplying a value obtained by subtracting the power amount ep1 at the rental end time from the power amount ep0 at the rental start time by a predetermined constant. Then, the rental fee calculation part 136 multiplies the calculated basic rental fee d1 by the selected first coefficient ds_rate and second coefficient dp_rate to calculate a final rental fee d3.

Next, in step S14, the output part 137 outputs the final rental fee of the battery pack 4 calculated by the rental fee calculation part 136. The communication part 11 transmits information indicating the final rental fee of the battery pack 4 output by the output part 137 to the user terminal 2. The user terminal 2 receives the information indicating the final rental fee of the battery pack 4 transmitted by the server 1. Then, the user terminal 2 displays the final rental fee of the battery pack 4 rented out to the user.

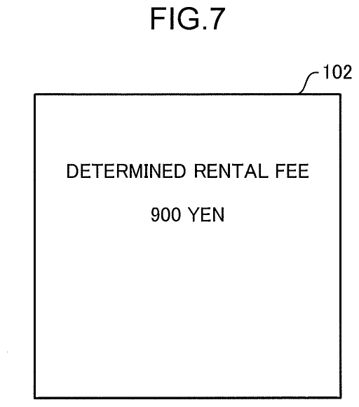

FIG. 7 is a diagram illustrating an example of a determined rental fee presentation image displayed on the user terminal 2 in the first embodiment. A display part of the user terminal 2 displays a determined rental fee presentation image 102 illustrated in FIG. 7.

The determined rental fee presentation image 102 illustrated in FIG. 7 includes the final rental fee of the battery pack 4 rented out to the user. The user can know the final rental fee of the battery pack 4 that the user rented by checking the determined rental fee presentation image 102 displayed on the user terminal 2.

Note that, in the first embodiment, a final rental fee at a rental end time is calculated and presented to the user, but the present disclosure is not particularly limited to this, and the final rental fee at the rental end time does not need to be calculated. The rental fee calculated in step S8 of FIG. 4 may be collected from the user.

Further, in the first embodiment, the battery pack 4 is rented, but the present disclosure is not particularly limited to this, and an electric mobile object on which the battery pack 4 is mounted may be rented. In this case, a battery pack station may have a parking facility for parking a plurality of electric mobile objects. The user rents a desired electric mobile object among a plurality of electric mobile objects. The electric mobile object may be charged at a battery pack station or may be charged at a place other than a battery pack station. In a case of charging at a place other than a battery pack station, a provider collects an electric mobile object placed in a battery pack station, charges the electric mobile object at a charging base, and carries the charged electric mobile object to a battery pack station. An electric mobile object may transmit information on a battery pack to the server 1.

Note that, in the first embodiment, the rental fee calculation part 136 multiplies the basic rental fee d1 by the first coefficient ds_rate and the second coefficient dp_rate. However, the present disclosure is not particularly limited to this, and the basic rental fee d1 may be multiplied by any of the first coefficient ds_rate and the second coefficient dp_rate.

Further, in a case where there is little usage history information, the rental fee calculation part 136 may not be able to calculate the first coefficient ds_rate and the second coefficient dp_rate. For this reason, in a case where sufficient use history information for calculating the first coefficient ds_rate is not accumulated, the rental fee calculation part 136 may set the first coefficient ds_rate to 1.0. Further, in a case where sufficient use history information for calculating the second coefficient dp_rate is not accumulated, the rental fee calculation part 136 may set the second coefficient dp_rate to 1.0.

As described above, based on deterioration degree, a charging rate, and initial full charge capacity of the battery pack 4 at a rental start time of the battery pack 4 mounted on the electric mobile object, a power amount of the battery pack 4 at the rental start time is calculated. Then, based on the calculated power amount, a rental fee of the battery pack 4 whose power amount is less than current full charge capacity is calculated, and the calculated rental fee is output.

Therefore, a rental fee of not only the battery pack 4 that is fully charged but also the battery pack 4 that is less than fully charged can be presented, and the number of the rentable battery packs 4 increases, so that a shortage of the rentable battery packs 4 can be prevented.

Further, in the first embodiment, a rental fee of the battery pack 4 that is not fully charged is calculated and output. If a power amount necessary for an electric mobile object to move from a departure point to a destination point remains in the battery pack 4, even the battery pack 4 that is not fully charged is a rental target. In particular, if an SOC at a rental start time is low, a rental fee is reduced, so that the battery pack 4 that is not fully charged is rented out to more users. Therefore, it is possible to prevent a shortage of the rentable battery packs 4.

### Second Embodiment

In the first embodiment, the first coefficient ds_rate set for each of a plurality of battery pack stations and the second coefficient dp_rate set for each of a plurality of predetermined SOC ranges are calculated, but in the second embodiment, a third coefficient, a fourth coefficient, and a fifth coefficient set with respect to a relationship between a moving distance per rental in the past of the user who rents a battery pack and a current scheduled power consumption amount are further calculated.

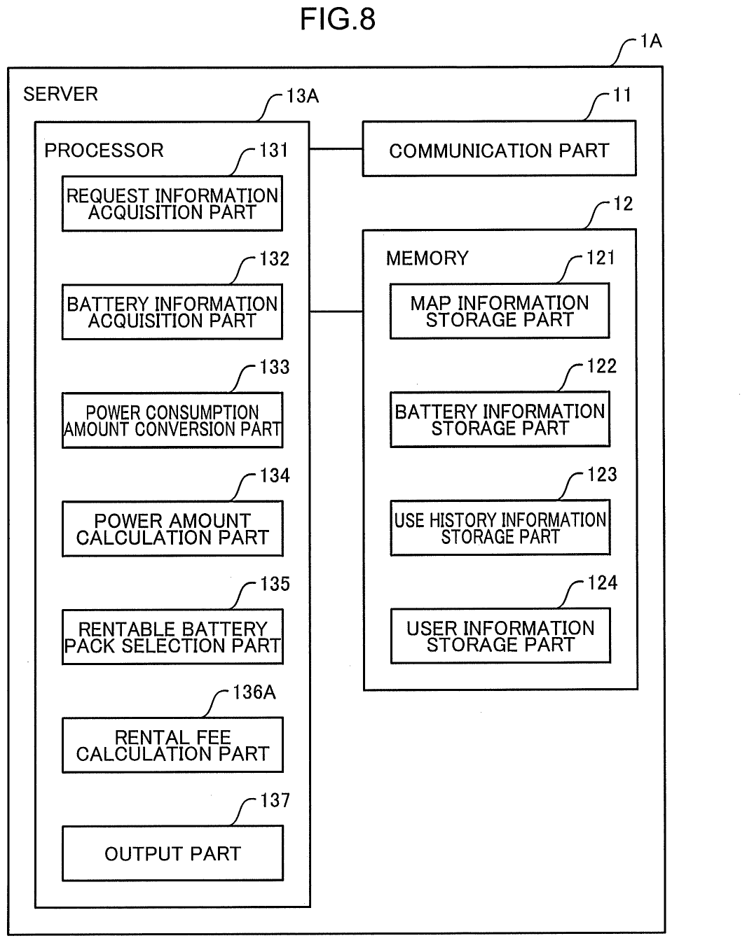

FIG. 8 is a block diagram illustrating a configuration of a server 1A in the second embodiment of the present disclosure.

The server 1A includes the communication part 11, the memory 12, and a processor 13A. Note that, in the second embodiment, the same configuration as that in the first embodiment will be denoted by the same reference sign as that in the first embodiment, and will be omitted from description.

The processor 13A realizes the request information acquisition part 131, the battery information acquisition part 132, the power consumption amount conversion part 133, the power amount calculation part 134, the rentable battery pack selection part 135, a rental fee calculation part 136A, and the output part 137.

The rental fee calculation part 136A calculates a rental fee of the battery pack 4 whose power amount is less than current full charge capacity based on a power amount calculated by the power amount calculation part 134. The rental fee calculation part 136A calculates a rental fee of the rentable battery pack 4 selected by the rentable battery pack selection part 135.

Similarly to the first embodiment, the rental fee calculation part 136A calculates the operation rate os_rate in the past of a battery pack station in which the battery pack 4 is placed, and calculates the first coefficient ds_rate set for the battery pack station based on the calculated operation rate os_rate. Further, similarly to the first embodiment, the rental fee calculation part 136A calculates the rental ratio op_rate of a plurality of the battery packs 4 rented in the past for each of a plurality of predetermined SOC ranges, and calculates the second coefficient dp_rate set for each of a plurality of predetermined SOC ranges based on the calculated rental ratio op_rate for each of a plurality of predetermined SOC ranges.

Furthermore, the rental fee calculation part 136A converts a moving distance per rental in the past of the user who rents the battery pack 4 into a power consumption amount. In a case where a current scheduled power consumption amount of the battery pack 4 is smaller than a value obtained by subtracting a threshold from the converted power consumption amount, the rental fee calculation part 136A multiplies a rental fee by a third coefficient du1_rate. The threshold is, for example, 20% of a converted power consumption amount. Further, in a case where a scheduled power consumption amount is within a range between a value obtained by subtracting the threshold from a converted power consumption amount and a value obtained by adding the threshold to the converted power consumption amount, the rental fee calculation part 136A multiplies a rental fee by a fourth coefficient du2_rate higher than the third coefficient du1_rate. Further, in a case where a scheduled power consumption amount is larger than a value obtained by adding the threshold to a converted power consumption amount, the rental fee calculation part 136A multiplies a rental fee by a fifth coefficient du3_rate higher than the fourth coefficient du2_rate.

Next, battery pack rental processing of the server 1A according to the second embodiment of the present disclosure will be described.

The battery pack rental processing of the server 1A in the second embodiment of the present disclosure is the same as the battery pack rental processing of the server 1 in the first embodiment illustrated in FIG. 4. The rental fee calculation processing in step S8 is different between the second embodiment and the first embodiment.

Here, the rental fee calculation processing of the rental fee calculation part 136A in the present second embodiment will be described in more detail.

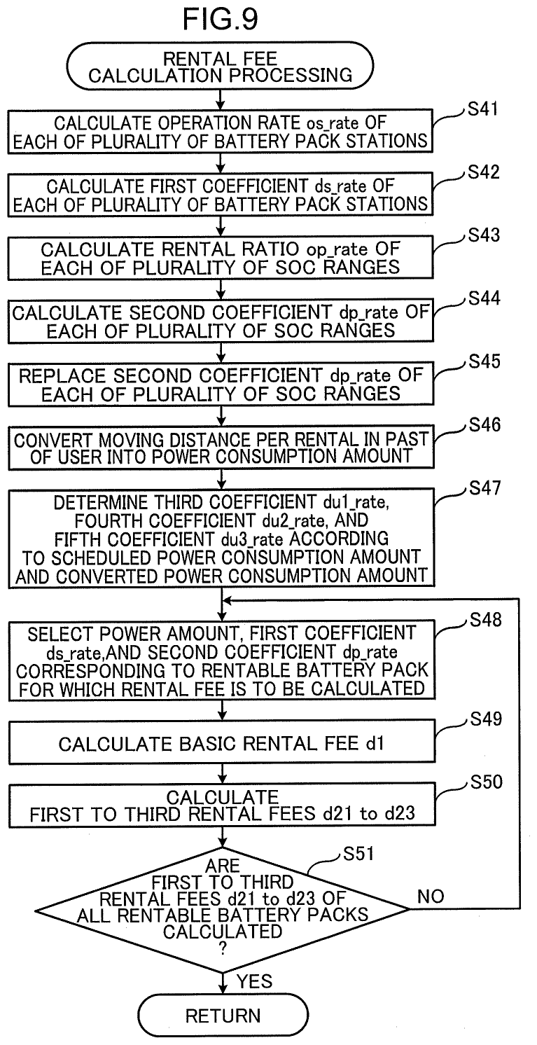

FIG. 9 is a flowchart for describing the rental fee calculation processing of the rental fee calculation part 136A in the second embodiment.

Processing in steps S41 to S45 is the same as the processing in steps S21 to S25 illustrated in FIG. 5, and will be omitted from description.

Next, in step S46, the rental fee calculation part 136A converts a moving distance per rental in the past of the user who rents the rentable battery pack 4 into a power consumption amount. The rental fee calculation part 136A calculates an average of moving distances on the same days of the week as today in a previous month of the user who rents the rentable battery pack 4, and converts the average of moving distances on the same days of the week as today in a previous month into a power consumption amount. Similarly to the power consumption amount conversion part 133, the rental fee calculation part 136A converts a moving distance into a power consumption amount.

For example, if today is Monday, the rental fee calculation part 136A calculates an average of moving distances on all Mondays in a previous month, and converts the calculated average of moving distances into a power consumption amount.

Note that, in the second embodiment, an average of moving distances is calculated from user information for one month of a previous month, but the present disclosure is not particularly limited to this, and an average of moving distances may be calculated from user information for one year. Further, a moving distance per movement in a previous month may be calculated regardless of a day of the week.

Next, in step S47, the rental fee calculation part 136A determines the third coefficient du1_rate, the fourth coefficient du2_rate, and the fifth coefficient du3_rate according to a current scheduled power consumption amount of the battery pack 4 and a converted power consumption amount.

The rental fee calculation part 136A determines the third coefficient du1_rate that is set in a case where a current scheduled power consumption amount of the battery pack 4 is smaller than a value obtained by subtracting a threshold from a converted power consumption amount. The threshold is, for example, 20% of a converted power consumption amount. The third coefficient du1_rate is determined by a provider in advance and is, for example, 0.8. Further, the rental fee calculation part 136A determines the fourth coefficient du2_rate higher than the third coefficient du1_rate that is set in a case where a scheduled power consumption amount is within a range between a value obtained by subtracting the threshold from a converted power consumption amount and a value obtained by adding the threshold to the converted power consumption amount. The fourth coefficient du2_rate is determined by a provider in advance and is, for example, 1.0. Further, the rental fee calculation part 136A determines the fifth coefficient du3_rate higher than the fourth coefficient du2_rate that is set in a case where a scheduled power consumption amount is larger than a value obtained by adding the threshold to a converted power consumption amount. The fifth coefficient du3_rate is determined by a provider in advance and is, for example, 1.1.

Processing in steps S48 and S49 is the same as the processing in steps S26 and S27 illustrated in FIG. 5, and will be omitted from description.

Next, in step S50, the rental fee calculation part 136 multiplies the basic rental fee d1 calculated in step S49 by the selected first coefficient ds_rate, the selected second coefficient dp_rate, and any one of the determined third coefficient du1_rate to fifth coefficient du3_rate to calculate first to third rental fees d21 to d23.

The rental fee calculation part 136 calculates the first rental fee d21 by multiplying the basic rental fee d1 calculated in step S49 by the selected first coefficient ds_rate, the selected second coefficient dp_rate, and the determined third coefficient du1_rate. Further, the rental fee calculation part 136 calculates the second rental fee d22 by multiplying the basic rental fee d1 calculated in step S49 by the selected first coefficient ds_rate, the selected second coefficient dp_rate, and the determined fourth coefficient du2_rate. Further, the rental fee calculation part 136 calculates the third rental fee d23 by multiplying the basic rental fee d1 calculated in step S49 by the selected first coefficient ds_rate, the selected second coefficient dp_rate, and the determined fifth coefficient du3_rate.

The first rental fee d21 is a rental fee charged in a case where a current scheduled power consumption amount of the battery pack 4 is smaller than a value obtained by subtracting a threshold from a converted power consumption amount. The second rental fee d22 is a rental fee charged in a case where a current scheduled power consumption amount of the battery pack 4 is within a range between a value obtained by subtracting a threshold from a converted power consumption amount and a value obtained by adding a threshold to the converted power consumption amount. Further, the third rental fee d23 is a rental fee charged in a case where a current scheduled power consumption amount of the battery pack 4 is larger than a value obtained by adding a threshold to a converted power consumption amount.

Processing in step S51 is the same as the processing in step S29 illustrated in FIG. 5, and will be omitted from description.

In step S9 of FIG. 4, the output part 137 outputs first to third rental fees for a plurality of the rentable battery packs 4 calculated by the rental fee calculation part 136A. The communication part 11 transmits, to the user terminal 2, information indicating the first to third rental fees of a plurality of the rentable battery packs 4 output by the output part 137. The user terminal 2 receives the information indicating the first to third rental fees of a plurality of the rentable battery packs 4 transmitted by the server 1. Then, the user terminal 2 displays the first to third rental fees of a plurality of the rentable battery packs 4.

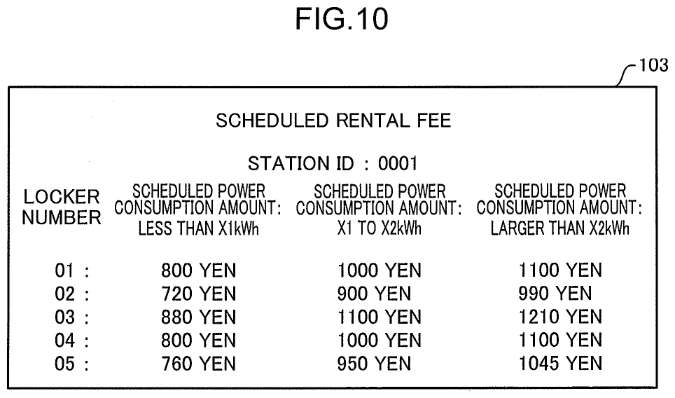

FIG. 10 is a diagram illustrating an example of a scheduled rental fee presentation image displayed on the user terminal 2 in the second embodiment. A display part of the user terminal 2 displays a scheduled rental fee presentation image 103 illustrated in FIG. 10.

The scheduled rental fee presentation image 103 shown in FIG. 10 includes a plurality of scheduled rental fees of a plurality of the rentable battery packs 4. The scheduled rental fee presentation image 103 includes a station ID of a battery pack station, a number of a locker installed in a battery pack station, and first to third scheduled rental fees of a battery packs stored in each locker. The first to third rental fees are presented for each battery pack station.

The scheduled rental fee presentation image 103 includes a first rental fee in a case where a scheduled power consumption amount is smaller than a value (for example, X1 kWh) obtained by subtracting a threshold from a converted power consumption amount, a second rental fee in a case where the scheduled power consumption amount is within a range between a value (for example, X1 kWh) obtained by subtracting the threshold from the converted power consumption amount and a value (for example, X2 kWh) obtained by adding the threshold to the converted power consumption amount, and a third rental fee in a case where the scheduled power consumption amount is larger than a value (for example, X2 kWh) obtained by adding the threshold to the converted power consumption amount.

The first to third rental fees corresponding to a scheduled power consumption amount are presented for each of a plurality of the rentable battery packs 4. By checking the scheduled rental fee presentation image 103 displayed on the user terminal 2, the user can know rental fees of a plurality of the rentable battery packs 4 according to his or her scheduled power consumption amount, and can determine which of the battery packs 4 to rent. Further, if a current power consumption amount is smaller than a power consumption amount at the time of rental in the past, a rental fee is also reduced, so that it is possible to encourage the user to use the battery pack 4 in a manner that a power consumption amount is reduced.

Further, the rental fee calculation part 136A calculates a final rental fee of the battery pack 4 based on the power amount ep1 at a rental end time calculated by the power amount calculation part 134. At this time, the rental fee calculation part 136A selects the power amount ep0, the first coefficient ds_rate, and the second coefficient dp_rate at a rental start time corresponding to a rented battery pack. The rental fee calculation part 136A calculates the basic rental fee d1 by multiplying a value obtained by subtracting the power amount ep1 at the rental end time from the power amount ep0 at the rental start time by a predetermined constant. The rental fee calculation part 136A determines any of the third coefficient du1_rate, the fourth coefficient du2_rate, and the fifth coefficient du3_rate according to a value obtained by subtracting the power amount ep1 at the rental end time from the power amount ep0 at the rental start time, that is, a power consumption amount. Then, the rental fee calculation part 136A calculates the final rental fee d3 by multiplying the calculated basic rental fee d1 by the selected first coefficient ds_rate, the selected second coefficient dp_rate, and any one of the determined third coefficient du1_rate to fifth coefficient du3_rate.

Note that, in each of the above embodiments, each constituent element may be implemented by including dedicated hardware or by executing a software program suitable for each constituent element. Each constituent element may be implemented by a program execution part, such as a CPU or a processor, reading and executing a software program recorded in a recording medium such as a hard disk or a semiconductor memory. Further, a program may be performed by another independent computer system by recording and transferring the program onto a recording medium or transferring the program via a network.

Some or all functions of the device according to the embodiment of the present disclosure are implemented as large scale integration (LSI), which is typically an integrated circuit. These may be individually integrated into one chip, or may be integrated into one chip so as to include some or all of them. Further, circuit integration is not limited to LSI, and may be implemented by a dedicated circuit or a general-purpose processor. A field programmable gate array (FPGA), which can be programmed after manufacturing of LSI, or a reconfigurable processor in which connection and setting of circuit cells inside LSI can be reconfigured may be used.

Further, some or all functions of the devices according to the embodiments of the present disclosure may be realized by a processor such as a CPU executing a program.

Further, all numbers used above are illustrated to specifically describe the present disclosure, and the present disclosure is not limited to the illustrated numbers.

Further, order in which steps illustrated in the above flowchart are executed is for specifically describing the present disclosure, and may be any order other than the above order as long as a similar effect is obtained. Further, some of the above steps may be executed simultaneously (in parallel) with other steps.

The technique according to the present disclosure can prevent a shortage of rentable batteries, and is useful as a technique for calculating a rental fee of a battery mounted on an electric mobile object.

1. An information processing method in a computer, the method comprising:
acquiring deterioration degree, a charging rate, and initial full charge capacity of a battery mounted on an electric mobile object at a rental start time of the battery;
calculating a power amount of the battery at the rental start time based on the deterioration degree, the charging rate, and the initial full charge capacity;
calculating a rental fee of the electric mobile object incorporating the battery having the power amount less than current full charge capacity or a rental fee of the battery having the power amount less than current full charge capacity based on the power amount; and
outputting the rental fee.

2. The information processing method according to claim 1, wherein
in the calculating a rental fee, the rental fee is calculated by multiplying the power amount at the rental start time by a predetermined constant.

3. The information processing method according to claim 1, wherein
in the calculating a rental fee, deterioration degree and a charging rate of the battery at a scheduled rental end time of the battery are estimated, a power amount at the scheduled rental end time is calculated based on the deterioration degree, the charging rate, and the initial full charge capacity of the battery at the scheduled rental end time, and a value obtained by subtracting the power amount at the scheduled rental end time from the power amount at the rental start time is multiplied by a predetermined constant to calculate the rental fee.

4. The information processing method according to claim 1, wherein
in the calculating a rental fee, an operation rate in past of a battery station in which the battery is placed is calculated, a first coefficient set for the battery station is calculated based on the operation rate that is calculated, and the first coefficient that is calculated is multiplied by the rental fee.

5. The information processing method according to claim 1, wherein
in the calculating a rental fee, a rental ratio at which a plurality of batteries are rented in past is calculated for each of a plurality of predetermined charging rate ranges, a second coefficient set for each of the plurality of predetermined charging rate ranges is calculated based on the rental ratio for each of the plurality of predetermined charging rate ranges that is calculated, and the rental fee is multiplied by the second coefficient set for a range corresponding to the charging rate of the battery among the plurality of predetermined charging rate ranges.

6. The information processing method according to claim 5, wherein
in a case where a second coefficient set for a first charging rate range is larger than a second coefficient set for a second charging rate range larger than the first charging rate range, the second coefficient set for the second charging rate range is replaced with the second coefficient set for the first charging rate range.

7. The information processing method according to claim 1, wherein
in the calculating a rental fee, a moving distance per rental in past of a user who rents the battery is converted into a power consumption amount, in a case where a current scheduled power consumption amount of the battery is smaller than a value obtained by subtracting a threshold from the power consumption amount that is converted, the rental fee is multiplied by a third coefficient, in a case where the scheduled power consumption amount is within a range between a value obtained by subtracting the threshold from the power consumption amount that is converted and a value obtained by adding the threshold to the power consumption amount that is converted, the rental fee is multiplied by a fourth coefficient higher than the third coefficient, and in a case where the scheduled power consumption amount is larger than a value obtained by adding the threshold to the power consumption amount that is converted, the rental fee is multiplied by a fifth coefficient higher than the fourth coefficient.

8. The information processing method according to claim 1, further comprising:
acquiring a departure point and a destination point of the electric mobile object on which the battery is mounted;
converting a moving distance from the departure point to the destination point into a power consumption amount; and
selecting a rentable battery in which the power amount of the battery at the rental start time is larger than the power consumption amount that is converted,
wherein in the calculating a rental fee, the rental fee of the rentable battery that is selected is calculated.

9. The information processing method according to claim 1, further comprising:
acquiring deterioration degree, a charging rate, and initial full charge capacity of the battery at a rental end time of the battery;
calculating a power amount at the rental end time based on the deterioration degree, the charging rate, and the initial full charge capacity;
calculating a final rental fee of the battery based on the power amount; and
outputting the final rental fee.

10. An information processing device comprising:
an acquisition part that acquires deterioration degree, a charging rate, and initial full charge capacity of a battery mounted on an electric mobile object at a rental start time of the battery;
a power amount calculation part that calculates a power amount of the battery at the rental start time based on the deterioration degree, the charging rate, and the initial full charge capacity;
a rental fee calculation part that calculates a rental fee of the electric mobile object incorporating the battery having the power amount less than current full charge capacity or a rental fee of the battery having the power amount less than current full charge capacity based on the power amount; and
an output part that outputs the rental fee.

11. A non-transitory computer readable recording medium storing an information processing program that causes a computer to function to:
acquire deterioration degree, a charging rate, and initial full charge capacity of a battery mounted on an electric mobile object at a rental start time of the battery;
calculate a power amount of the battery at the rental start time based on the deterioration degree, the charging rate, and the initial full charge capacity;
calculate a rental fee of the electric mobile object incorporating the battery having the power amount less than current full charge capacity or a rental fee of the battery having the power amount less than current full charge capacity based on the power amount; and
output the rental fee.
